(19) United States
(12) Patent Application Publication
(10) Pub. No.: US 2008/0223881 A1
(43) Pub. Date: Sep. 18, 2008

(54) Trigger Sprayer Having a Two-Piece Shroud with Top and Bottom Pieces

(75) Inventor: Walter J. Clynes, O'Fallon, MO (US)

Correspondence Address: THOMPSON COBURN, LLP, ONE US BANK PLAZA, SUITE 3500, ST LOUIS, MO, 63101, US

(73) Assignee: CONTINENTALAFA DISPENSING COMPANY, St. Peters, MO (US)

(21) Appl. No.: 11/684,829

(22) Filed: Mar. 12, 2007

(51) Int. Cl. B05B 11/00

(52) U.S. Cl. 222/383.1

(57) ABSTRACT

A trigger sprayer that is manually held and operated to pump liquid from an attached bottle and dispense the liquid in a selected discharge pattern from the trigger sprayer has an aesthetically appearing shroud that is comprised of only two pieces that snap together over the exterior of the trigger sprayer housing.

### BACKGROUND OF THE INVENTION

1. Field of the Invention

The present invention pertains to a trigger sprayer of the type that is manually held and operated to pump liquid from an attached bottle and dispense the liquid in a selected discharge pattern from the trigger sprayer. In particular, the present invention pertains to a trigger sprayer having an aesthetically appearing shroud that is comprised of only two pieces that snap together over the exterior of the trigger sprayer housing.

2. Description of the Related Art

Hand-held and hand-operated liquid dispensers known as trigger sprayers are used to dispense liquid products such as cleaning liquids. A trigger sprayer is typically connected to a bottle containing the liquid that is dispensed by the manual operation of the trigger sprayer.

The typical construction of a trigger sprayer includes a sprayer housing that is connected to the neck of a bottle by either a threaded connection or a bayonet-type connection. The sprayer housing is typically molded of plastic and is formed with a pump chamber, a liquid supply passage communicating with the pump chamber, and a liquid discharge passage communicating with the pump chamber. The sprayer housing includes a pump chamber opening on the exterior of the housing that communicates with the pump chamber. A liquid inlet opening on the exterior of the housing communicates with the liquid supply passage, and a liquid discharge opening on the exterior of the housing communicates with the liquid discharge passage.

A dip tube is connected to the sprayer housing at the liquid inlet opening. The dip tube extends into the liquid contents of the bottle attached to the sprayer housing and communicates the liquid through the liquid supply passage with the pump chamber.

A nozzle assembly is assembled to the sprayer housing at the liquid outlet opening. Some nozzle assemblies include features that enable the adjustment of the pattern of the liquid discharged from the trigger sprayer. For example, the nozzle assembly can be adjusted between an “off” position where discharge from the trigger sprayer is prevented, and one or more “on” positions where liquid discharge from the trigger sprayer is permitted, and the liquid discharge can be a spray, stream, or foam pattern of discharge.

A pump piston is inserted into the pump chamber through the pump chamber opening on the sprayer housing. The pump piston is mounted in the pump chamber for reciprocating movements between charge and discharge positions of the piston in the pump chamber. When the piston is moved to the charge position, a vacuum is created in the pump chamber that draws liquid through the dip tube and the liquid supply passage into the pump chamber. When the piston is moved to the discharge position, the liquid in the pump chamber is forced through the liquid discharge passage and out of the sprayer housing through the nozzle assembly.

A trigger is mounted on the sprayer housing for movement of the trigger relative to the sprayer housing. Typically, the trigger pivots relative to the sprayer housing. However, other types of movements are possible. The trigger is operatively connected to the pump piston to cause the reciprocating movements of the pump piston in the pump chamber in response to movements of the trigger.

Inlet and outlet check valves are assembled into the sprayer housing. The check valves control the flow of liquid through the liquid supply passage to the pump chamber, and the flow of liquid from the pump chamber and through the liquid discharge passage.

Because trigger sprayers are often visible at their point of purchase, it is important that the trigger sprayers have a desirable appearance to attract consumers. Trigger sprayers have been provided with aesthetically designed shrouds that attach to the sprayer housing. The shrouds cover over much of the sprayer housing above the bottle connector. They conceal the functional appearance of the liquid discharge passage and the liquid outlet opening, the pump chamber, and the liquid supply passage from viewing from the top, back, and sides of the trigger sprayer. Thus, the typical shroud provides an aesthetically pleasing appearance to the trigger sprayer. However, the prior art design of shrouds does not completely cover over and improve the appearance of all of the functional components of the typical trigger sprayer. Prior art shrouds have been designed with large openings at the front and bottom of the shroud that enable the shroud to be assembled onto the exterior of the trigger sprayer housing. The prior art trigger sprayer shroud typically covers over only the top, back and opposite sides of the sprayer housing, with the bottom and front of the sprayer housing all being exposed. The bottle connector of the trigger sprayer is visible beneath the shroud and the front of the sprayer housing to which the nozzle assembly, trigger, and pump piston are assembled are all visible through the front opening of the shroud. Thus, prior art trigger sprayer shrouds are disadvantaged in that they do not provide an aesthetically pleasing appearance to a majority of the functional components of the trigger sprayer.

In addition to the above, prior art shrouds and trigger sprayer housings used with the shrouds are designed to include features that enable attachment of the shroud to the trigger sprayer housing. This often results in only one design of a shroud that may be attached to only one sprayer housing. The attachment mechanisms required between the shroud and the sprayer housing increase the costs associated with manufacturing the shroud and sprayer housing, and limit the use of only one shroud construction with only one complementary sprayer housing construction.

### SUMMARY OF THE INVENTION

The present invention overcomes the above-described disadvantages associated with prior art trigger sprayer shrouds by providing a two-piece shroud construction that covers over and provides an aesthetically pleasing appearance to much of the exterior of a trigger sprayer, more so than prior art trigger sprayer shrouds. In addition, the two-piece shroud construction of the present invention is easily assembled to the trigger sprayer housing by the two pieces being snapped together around the sprayer housing. This enables the two-piece shroud construction of the invention to be employed on various different types of trigger sprayers having different sprayer housing configurations, without requiring that the sprayer housing construction be specifically designed to attach to the shroud.

Much of the construction of the trigger sprayer of the invention, apart from the novel construction of the shroud, is conventional. The novel shroud of the invention is intended for use with various known types of manually operated trigger sprayers, and therefore the particular construction of the trigger sprayer on which the shroud is described herein is illustrative only and is not intended to be limiting. Because the novel construction of the shroud of the invention may be employed on various different types of trigger sprayers, the component parts of the trigger sprayer are described only generally herein.

The trigger sprayer includes a sprayer housing that contains a pump chamber having a pump chamber opening on the housing. A liquid inlet opening is also provided on the sprayer housing, and a liquid supply passage communicates the liquid inlet opening with the pump chamber. A liquid outlet opening is provided on the sprayer housing, and a liquid discharge passage communicates the pump chamber with a liquid outlet opening. In the illustrated embodiment, the sprayer housing also includes an integral bottle connector having a bayonet-type connection. Other types of bottle connectors, for example an internal and screw-threaded connector, may be used.

A pump piston is assembled into the pump chamber of the sprayer housing, and a piston rod projects outwardly from the pump chamber opening on the sprayer housing. A trigger is mounted on the sprayer housing for movement relative to the sprayer housing. The trigger is operatively connected to the pump piston rod for reciprocating the pump piston in the pump chamber in response to manual movements of the trigger. A nozzle assembly is also assembled to the sprayer housing at the liquid discharge opening. All of these functional features of the trigger sprayer are common to most trigger sprayers.

The novel shroud of the invention is attached to the sprayer housing and provides an aesthetically pleasing cover for most of the functional features of the trigger sprayer. The shroud of the invention is comprised of only a lower shroud piece and an upper shroud piece that are assembled together over the trigger sprayer housing.

The lower shroud piece is tubular and has a hollow interior volume. A top edge of the lower shroud piece surrounds a top opening to the interior volume. A bottom edge of the lower shroud piece surrounds a bottom opening to the interior volume. The lower shroud piece is assembled to the trigger sprayer by inserting a lower portion of the sprayer housing through the lower shroud piece top opening and into the interior volume of the lower shroud piece. The sprayer housing is positioned in the interior of the lower shroud piece with the exterior surface of the lower shroud piece surrounding part of the pump chamber, the bottle connector, and liquid inlet opening of the lower portion of the sprayer housing. The interior of the lower shroud piece is provided with a plurality of mechanical attachments that attach the lower shroud piece to the sprayer housing, specifically to the bottle connector of the sprayer housing. With the lower shroud piece attached to the sprayer housing, an upper portion of the sprayer housing including part of the pump chamber, the liquid discharge passage and the liquid outlet opening extends outwardly from the top opening of the lower shroud piece.

The upper shroud piece is assembled to the lower shroud piece with the upper shroud piece covering over the top opening of the lower shroud piece and covering over the upper portion of the sprayer housing. A plurality of mechanical attachments attach the upper shroud piece to the lower shroud piece, with there being no attachments between the upper shroud piece and the sprayer housing. In the preferred embodiment, the mechanical attachments include two-part, snap-on connectors. The first connector part is provided on the lower shroud piece and the second connector part is provided on the upper shroud piece. The two-part, snap-on connectors are pressed together in attaching the upper shroud piece to the lower shroud piece.

With the upper shroud piece attached to the lower shroud piece, a majority of the functional features of the trigger sprayer are covered over by the exterior surfaces of the lower shroud piece and the upper shroud piece. This gives a majority of the trigger sprayer the aesthetically pleasing appearance of the shroud of the present invention. Only the nozzle assembly, the trigger, and the pump piston rod extend outwardly from and are visible outside of the exterior surfaces of the lower shroud piece and the upper shroud piece when viewing the trigger sprayer from either side. In this manner, the two-piece shroud of the present invention provides an aesthetically pleasing appearance over a majority of the trigger sprayer functional features, and is easily assembled over the trigger sprayer, enabling the two-piece shroud of the invention to be employed on a variety of different types of trigger sprayers.

### DESCRIPTION OF THE DRAWINGS FIGURES

Further features of the invention are set forth in the following detailed description of the preferred embodiment of the invention and in the drawing figures.

FIG. 1 is a side elevation view of a trigger sprayer enclosed in the two-piece shroud of the present invention.

FIG. 2 is a front elevation view of the trigger sprayer and shroud shown in FIG. 1.

FIG. 3 is a rear elevation view of the trigger sprayer and shroud shown in FIG. 1.

FIG. 4 is a top plan view of the trigger sprayer and shroud shown in FIG. 1.

FIG. 5 is a bottom plan view of the trigger sprayer and shroud shown in FIG. 1.

FIG. 6 is a top, rear perspective view of the trigger sprayer and shroud shown in FIG. 1.

FIG. 7 is a bottom, rear perspective view of the trigger sprayer and shroud shown in FIG. 1.

FIG. 8 is a top, front perspective view of the trigger sprayer and shroud shown in FIG. 1.

FIG. 9 is a cross-section elevation view of the trigger sprayer and shroud shown in FIG. 1.

FIG. 10 is a cross-section unassembled perspective view of the two-piece shroud of the invention and the sprayer housing of the trigger sprayer shown in FIG. 1.

FIG. 11 is a perspective sectioned view similar to FIG. 10, but showing the portions of the two-piece shroud assembled to the trigger sprayer sprayer housing.

### DETAILED DESCRIPTION OF THE PREFERRED EMBODIMENT OF THE INVENTION

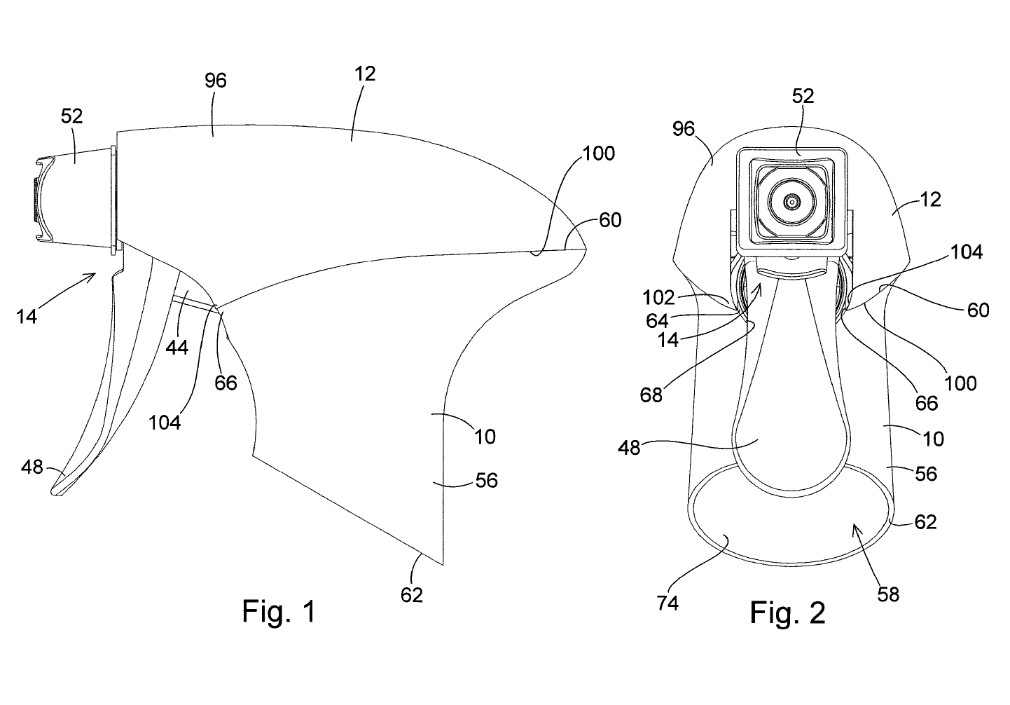

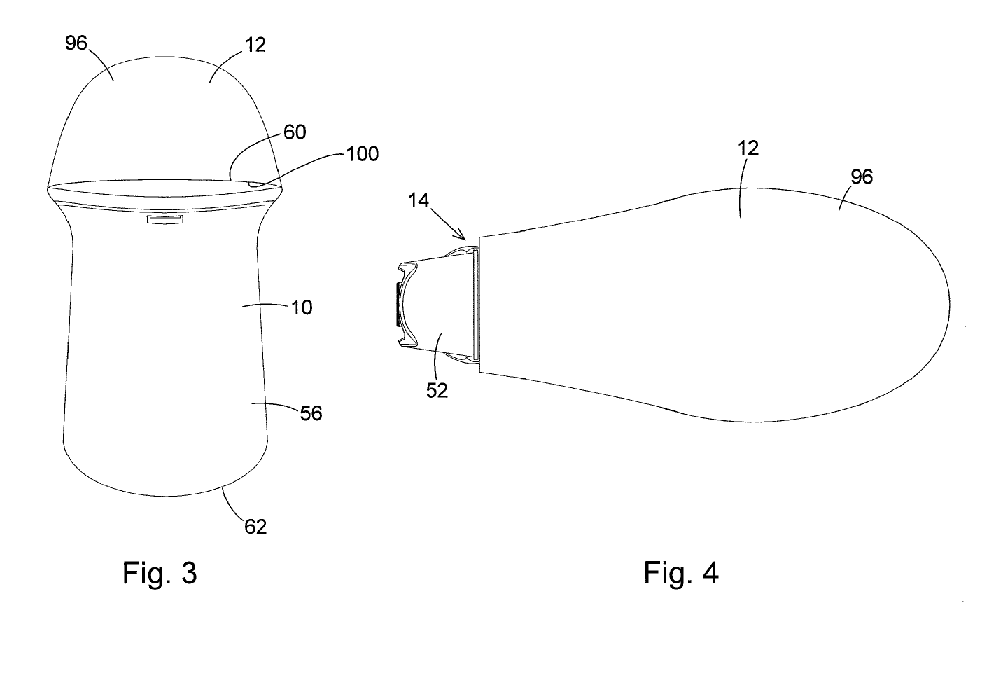

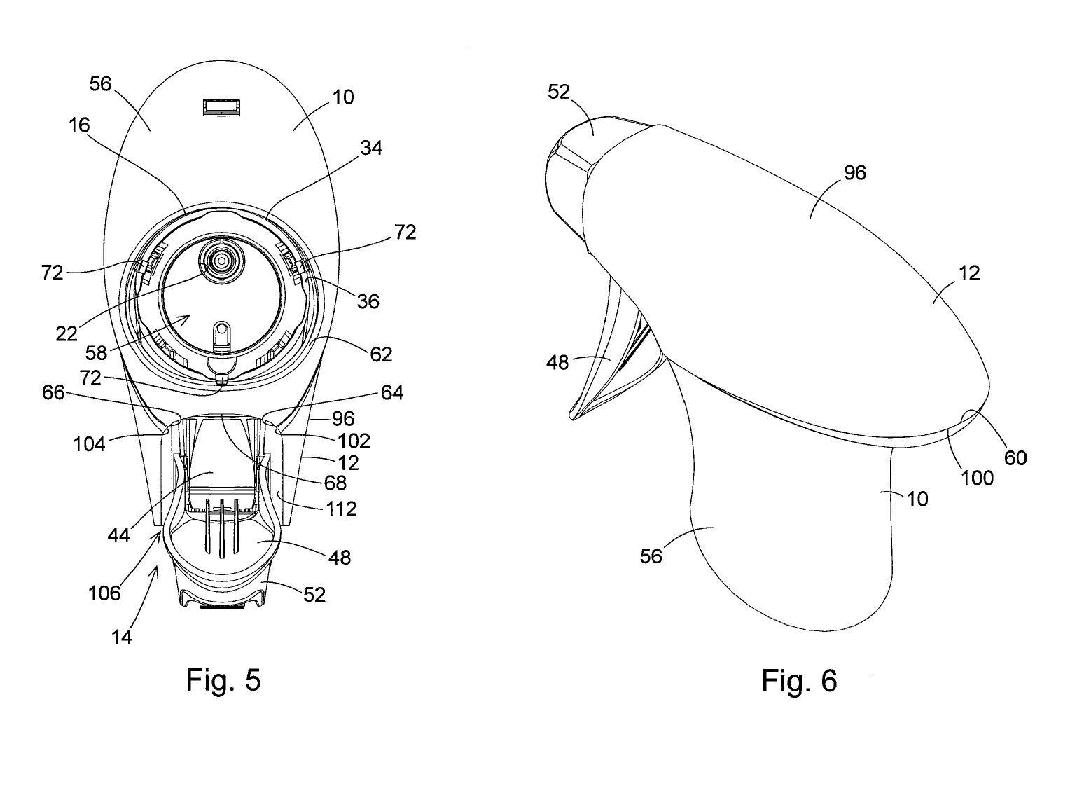

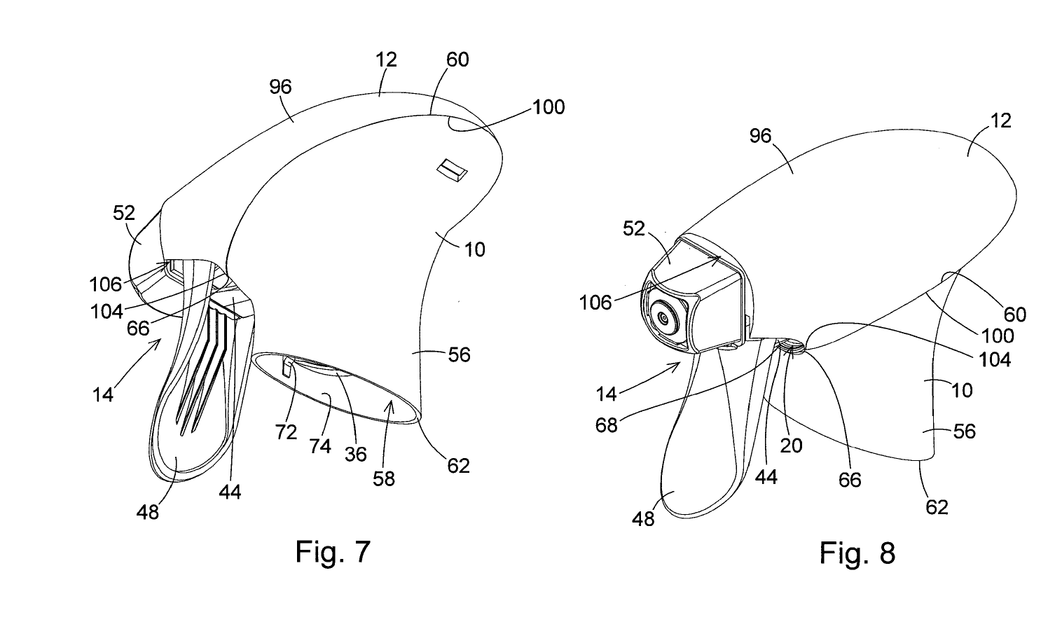

The present invention provides a two-piece shroud 10, 12 construction that covers over and provides an aesthetically pleasing appearance to much of the exterior of a trigger sprayer 14. FIGS. 1-8 show the two-piece 10, 12 shroud assembled on the exterior of a typical trigger sprayer 14. The trigger sprayer 14 to be described herein is only one example of the construction of a trigger sprayer with which the novel two-piece shroud 10, 12 may be used. Only minor modifications are needed to the construction of the trigger sprayer 14 to enable the mechanical attachment of the two-piece shroud 10, 12 over the exterior of the trigger sprayer. In addition, the two-piece shroud 10, 12 is easily assembled to the exterior of the trigger sprayer 14 by the two pieces 10, 12 being snapped together around the trigger sprayer 14. This also enables the two-piece shroud construction of the invention to be employed on various different types of trigger sprayers having different sprayer housing configurations.

Much of the construction of the trigger sprayer 14 shown in the drawing figures, apart from the novel construction of the two-piece shroud 10, 12 and the modifications to the trigger sprayer 14 that enable the assembly of the shroud on the trigger sprayer, is conventional. The novel shroud 10, 12 of the invention is intended for use with various known types of manually operated trigger sprayers, and therefore the particular construction of the trigger sprayer 14 on which the shroud 10, 12 is described is intended to be illustrative only, and is not intended to be limiting. Because the novel construction of the shroud 10, 12 of the invention may be employed on various different types of trigger sprayers, the component parts of the trigger sprayer 14 are described only generally herein, with the features of the trigger sprayer 14 required for the assembly of the two-piece shroud 10, 12 on the trigger sprayer are specifically identified.

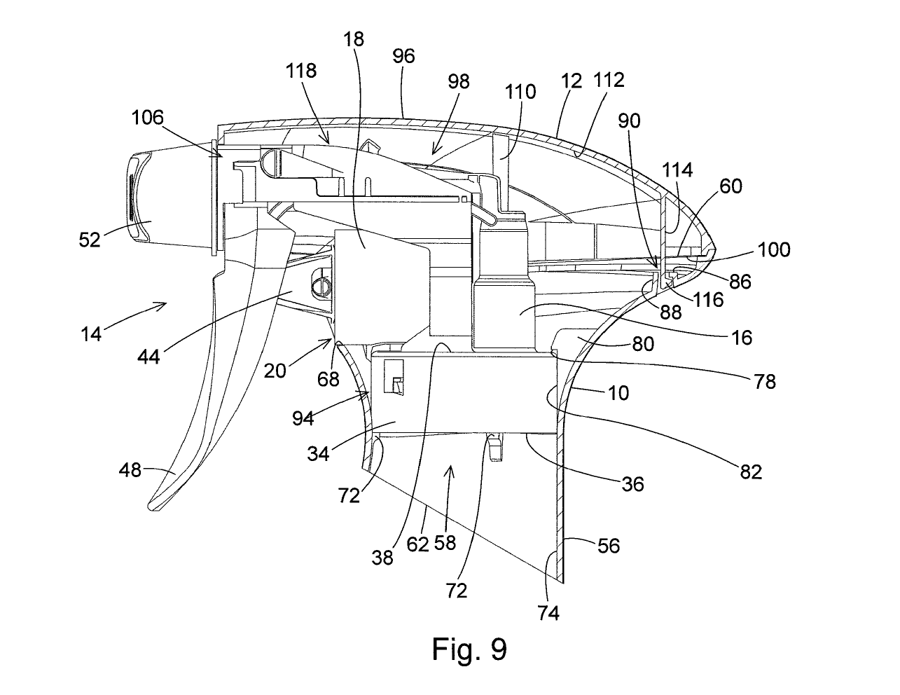

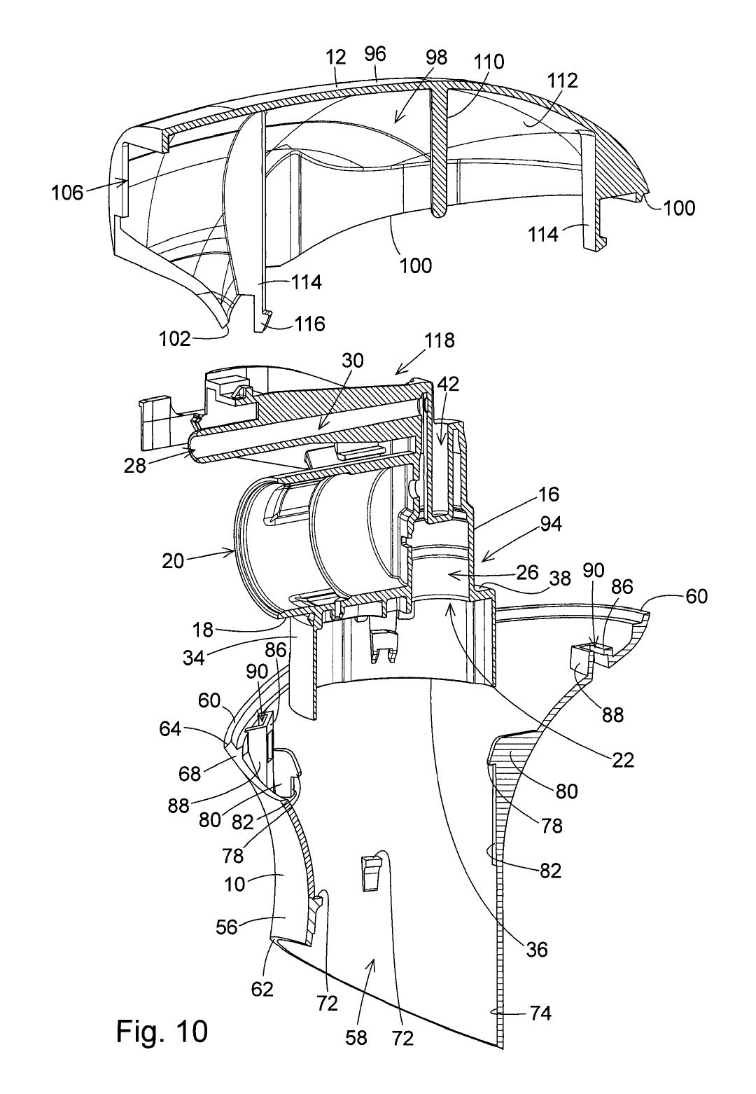

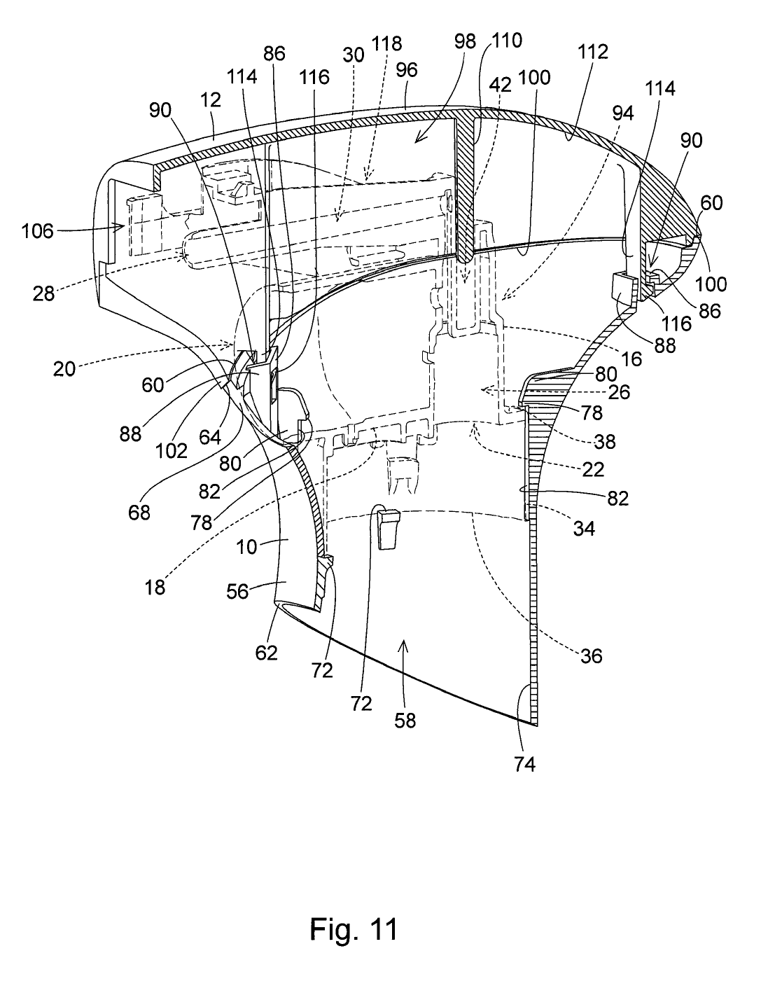

The construction of the trigger sprayer 14 is shown in the cross-section view of FIG. 9. The trigger sprayer includes a sprayer housing 16 that is also shown in FIGS. 10 and 11. The sprayer housing 16 contains a pump chamber 18 having a pump chamber opening 20 on the sprayer housing. A liquid inlet opening 22 is also provided on the sprayer housing. A liquid supply passage 26 extends through the sprayer housing and communicates the liquid inlet opening 22 with the pump chamber 18. A liquid outlet opening 28 is provided on the sprayer housing 16. A liquid discharge passage 30 extends through the sprayer housing 16 and communicates the pump chamber 18 with the liquid outlet opening 28. The sprayer housing 16 also includes a cylindrical bottle connector 34 that is integrally formed on the sprayer housing. The bottle connector 34 has a cylindrical side wall with a circular bottom edge 36 and a circular top edge 38. The bottle connector 34 shown in the drawing figures has a bayonet-type fitment that is adapted to attach the trigger sprayer 14 to the neck of a separate bottle. Other types of bottle connectors, for example an internal screw threaded connector, may be used as the bottle connector 34 of the sprayer housing 16.

The construction of the sprayer housing 16 described above is common to sprayer housings of many different types of trigger sprayers. A unique feature of the sprayer housing 16 that enables the attachment of the two-piece shroud 10, 12 to the sprayer housing is the deep-well socket 42 provided on the exterior of the sprayer housing 16. The socket 42 has an elongate, cylindrical length that extends downwardly from the top of the sprayer housing 16 into a portion of the liquid discharge passage 30 of the sprayer housing. This positions the socket 42 directly behind the pump chamber 18 of the sprayer housing 16. The socket 42 is coaxial with the liquid discharge passage 30 behind the pump chamber 18. The length of the socket 42 shown in the drawing figures is employed in assembling the two-piece shroud 10, 12 to the trigger sprayer 14, and specifically is employed in properly positioning the shroud upper piece 12 over the sprayer housing 16 in a manner to be described.

A dip tube (not shown) is typically assembled to the sprayer housing 16 at the liquid inlet opening 22. The dip tube has a length that extends into the liquid contained in the bottle to which the trigger sprayer 14 is attached. The dip tube communicates the liquid with the liquid supply passage 26 and the pump chamber 18 of the sprayer housing.

Valve assembles (not shown) are also typically assembled inside the sprayer housing 16. The valve assembles control the flow of liquid through the liquid supply passage 26 into the pump chamber 18, and control the flow of liquid from the pump chamber 18 through the liquid discharge passage 30. There are various different types of valve assemblies that are employed in the construction of trigger sprayers, and any of these valve assemblies may be used in the trigger sprayer of the invention.

A pump piston is assembled into the pump chamber 18 of the sprayer housing 16 in the conventional manner. The pump piston is operatively connected to a piston rod 44 that projects outwardly from the pump chamber opening 20.

A trigger 48 is mounted on the sprayer housing 16 for movement of the trigger relative to the sprayer housing. The trigger 48 is operatively connected to the pump piston rod 44 for reciprocating the pump piston in the pump chamber 18 in response to manual movements of the trigger 48.

A nozzle assembly 52 is also assembled to the sprayer housing 16. The nozzle assembly 52 is attached to the sprayer housing 16 at the liquid outlet opening 28. The nozzle assembly 52 is rotatable to change the pattern of liquid discharged from the trigger sprayer 14, or stop the discharge of liquid from the trigger sprayer.

The pump piston and piston rod 44, the trigger 48, and the nozzle assembly 52 described above are functional features of the trigger sprayer 14 that are common to most trigger sprayers.

The two-piece shroud 10, 12 of the invention is attached to the sprayer housing 16 and provides an anesthetically pleasing cover over most of the functional features of the trigger sprayer 14. The shroud is comprised of only the lower shroud piece 10 and the upper shroud piece 12. These two pieces 10, 12 are assembled together over the trigger sprayer housing 16 solely by mechanical attachments of the shroud pieces to each other, and to the sprayer housing. Furthermore, as will be explained, the mechanical attachments are integral with the shroud lower piece 10 and the shroud upper piece 12. No separate attachment mechanisms are required in assembling the two-piece shroud 10, 12 to the sprayer housing 16. The two-piece mechanical attachments provided integrally on the shroud lower piece 10 and the shroud upper piece 12 enable the two pieces to be attached together without the need for adhesives or other attachment means, for example RF welding.

FIGS. 10 and 11 show a cross-sectional view of the shroud lower piece 10. It should be understood that the shroud lower piece 10 has a monolithic tubular configuration as shown in FIGS. 2, 5, and 7. The tubular configuration of the shroud lower piece 10 is defined by a generally cylindrical lower piece wall 56 of the shroud lower piece 10. The lower piece wall 56 has an exterior surface and extends completely around an interior volume 58 contained inside the shroud lower piece 10. The cylindrical wall of the shroud lower piece 56 has a top edge 60 that surrounds a top opening to the lower piece interior volume 58. At the opposite end of the shroud lower piece, the wall 56 has a bottom edge 62 that surrounds a bottom opening to the lower piece interior volume 58. The bottom edge 62 has a continuous, oblong configuration. A majority of the top edge 60 has a continuous, elongated u-shaped configuration that begins at a first end 64 of the top edge and extends around the top opening to a second end 66 of the top edge. A generally semi-circular notch 68 is formed in the top edge 60 between the first end 64 and the second end 66 of the continuous, u-shaped portion of the top edge. The semi-circular notch 68 receives a lower portion of the sprayer housing pump chamber opening 20 as will be explained.

A plurality of bottom edge stops 72 are positioned on the interior surface 74 of the shroud lower piece 10. The bottom edge stops 72 are spatially arranged around the shroud lower piece interior volume 58. As seen in FIGS. 10 and 11, the bottom edge stops 72 are positioned in a single plane and project inwardly from the shroud lower piece interior surface 74.

A plurality of top edge stops 78 are positioned on the shroud lower piece interior surface 74 spaced above the bottom edge stops 72. The top edge stops 78 are also spatially arranged around the interior volume 58 of the shroud lower piece 10. The top edge stops 78 are positioned on resilient webs 80 that project inwardly from the shroud lower piece interior surface 74. The webs 80 have guide edges 82 that extend from the top edge stops 78 along a portion of the shroud lower piece interior surface 74. The projection of the webs 80 from the shroud lower piece interior surface 74 to the top edge stops 78 allows the top edge stops 78 to flex resiliently from side to side when a force is exerted on the top edge stops.

A plurality of hook latches 86 are formed integrally with the shroud lower piece 10 in the shroud lower piece interior volume 58. The hook latches 86 provide a first part of a two part mechanical attachment mechanism that attaches the shroud upper piece 12 to the shroud lower piece 10 in a manner to be explained. Each of the hook latches 86 is positioned at the top of a hollow rectangular column 88 that is formed integrally with the shroud lower piece interior surface 74. The columns 88 are spatially arranged around the interior volume 58 of the shroud lower piece 10. As seen in FIGS. 10 and 11, each of the hollow columns 88 has a top opening 90 adjacent the hook latch 86 of the column.

The sprayer housing 16 is assembled to the shroud lower piece 10 by first positioning the sprayer housing 16 over the opening defined by the lower piece top edge 60 as shown in FIG. 10. The sprayer housing 16 is then inserted through the opening defined by the top edge 60 and into the shroud lower piece interior volume 58 as shown. As the sprayer housing 16 is inserted into the shroud lower piece interior volume 58, the bottle connector 34 engages with the top edge stops 78 and resiliently flexes the top edge stops 78 so that they pass over the exterior surface of the bottle connector sidewall. The sprayer housing 16 is continued to move into the shroud lower piece interior volume 58 until the sidewall bottom edge 36 of the bottle connector 34 engages against the bottom edge stops 72. At this position of the sprayer housing 16 in the shroud lower piece interior volume 58, the top edge stops 78 will resiliently flex over the bottle connector top edge 38 and securely hold the sprayer housing 16 in the shroud lower piece interior volume 58. The sprayer housing 16 is shown in dashed lines in FIG. 11 attached to the shroud lower piece 10. With the sprayer housing 16 secured in the shroud lower piece, the shroud lower piece completely surrounds the sprayer housing bottle connector 34 and the liquid inlet opening 22 of the sprayer housing. In addition, the semi-circular notch 68 of the shroud lower piece 10 engages around a portion of the pump chamber 18 at the pump chamber opening 20. Only a portion of the pump chamber 18 projects outwardly from the shroud lower piece interior volume 58 through the top opening defined by the lower piece top edge 60. As represented by the dash lines in FIG. 11, the shroud lower piece 10 completely surrounds a lower portion 94 of the sprayer housing 16, with only a portion of the pump chamber 18 and a portion of the liquid discharge passage 30 and the liquid outlet opening 28 extending outwardly from the interior volume 58 of the shroud lower piece 10 through the top opening defined by the lower piece top edge 60.

The shroud upper piece 12 has a wall 96 that is formed in a generally inverted u-shape. The wall 96 extends around an interior volume 98 of the shroud upper piece 12. The wall 96 has a bottom edge 100 that extends in an elongate u-shape from a first end 102 of the edge, around the bottom of the shroud upper piece 12 to a second end 104 of the edge. The upper piece bottom edge 100 extends as a continuous elongate u-shaped curve from the first end 102 of the edge to the second end 104 of the edge. The shape of the upper piece bottom edge 100 is a mirror image of the shape of the lower piece top edge 60. The wall 96 of the shroud upper piece 112 extends as a smooth, continuous surface from the bottom edge 100 on one side of the shroud interior volume 98, upwardly and over the interior volume 98 and then downwardly to the opposite side of the edge 100. A front opening 106 is left in the shroud upper piece 12 between the first 102 and second 104 ends of the bottom edge 100. The front opening 106 is shaped to allow the attachment of the nozzle assembly 52 to the sprayer housing liquid outlet opening 28 through the front opening 106.

A positioning post 110 projects inwardly from the interior surface 112 of the shroud upper piece 12 into the interior volume 98 of the shroud upper piece. A plurality of resilient webs 114 also project from the shroud upper piece interior surface 112 into the interior volume 98 of the shroud upper piece. A hook 116 is formed on each of the resilient webs 114. The hook 116 forms the second part of the two-part mechanical attachments that connect the shroud upper piece 12 to the shroud lower piece 10 without the use of any external fasteners or any external attachment means. The resilient webs 114 and their associated hooks 116 are spatially arranged around the interior surface 112 of the shroud upper piece 12. The positioning of the webs 114 and hooks 116 coincides with the positioning of the hook latch columns 88 on the interior surface 74 of the shroud lower piece 10. In addition, the positioning post 110 is positioned on the interior surface 112 of the shroud upper piece 12 to coincide with the position of the sprayer housing socket 42 attached in the interior volume 58 of the shroud lower piece 10.

In attaching the shroud upper piece 12 to the shroud lower piece 10 with the sprayer housing 16 previously assembled in the shroud lower piece 10, the shroud upper piece 12 is positioned over the top opening defined by the top edge 60 of the shroud lower piece wall 58 as shown in FIG. 10. The shroud upper piece 12 is then moved downwardly onto the shroud lower piece 10, with an upper portion 118 of the sprayer housing 16 being inserted into the interior volume 98 of the shroud upper piece 12. The positioning post 110 on the shroud upper piece 12 is aligned with the socket 42 in the sprayer housing 16 and the hooks 116 on the shroud upper piece 12 are aligned with the hook latches 86 on the shroud lower piece 10. As the positioning post 110 on the shroud upper piece 12 is inserted into the socket 42 of the sprayer housing 16, the hooks 116 on the shroud upper piece 12 are inserted into the column top openings 90 of the hook latch columns 88. The resilience of the hook webs 114 on the shroud upper piece 12 allow the hooks 116 to deflect as they are inserted through the top openings 90 of the hook latch columns 88. This allows the hooks 116 on the shroud upper piece 12 to engage with the hook latches 86 on the shroud lower piece 10 in securing the shroud upper piece 12 to the shroud lower piece 10. The upper piece bottom edge 100 meets the lower piece top edge 60 to form a single continuous seam line around the shroud from the pump chamber opening on one side to the pump chamber opening on the opposite side. The two-part mechanical attachment of the shroud upper piece 12 to the shroud lower piece 10 provided by the hooks 1 16 and hook latches 86 are the only connections between the two shroud pieces.

With the shroud upper piece 12 attached to the shroud lower piece 10, the two-piece shroud construction of the invention covers over a substantial portion of the exterior of the trigger sprayer 14, with only the nozzle assembly 52, the trigger, 48, and a portion of the pump piston rod 44 projecting outwardly from the two-piece shroud 10, 12. This gives a majority of the trigger sprayer the aesthetically pleasing appearance of the shroud as shown in FIGS. 1-8. In this manner, the two-piece shroud of the present invention provides an aesthetically pleasing appearance over a major of the trigger sprayer functional features and is easily assembled over the trigger sprayer, enabling the two-piece shroud of the invention to be employed on a variety of different types of trigger sprayers.

1. A manually operated trigger sprayer comprising:
a sprayer housing having a pump chamber in the sprayer housing with a pump chamber opening on the sprayer housing, a liquid inlet opening on the sprayer housing, a liquid supply passage extending through the sprayer housing and communicating the liquid inlet opening with the pump chamber, a liquid outlet opening on the sprayer housing, and a liquid discharge passage extending through the sprayer housing and communicating the liquid outlet opening with the pump chamber;
a pump piston mounted in the pump chamber for reciprocating movement between charge and discharge positions of the pump piston in the pump chamber;
a trigger mounted on the sprayer housing for movement of the trigger relative to the sprayer housing, the trigger being operatively connected to the pump piston to cause movement of the pump piston in response to movement of the trigger;
a lower shroud piece mechanically attached to the sprayer housing, the lower shroud piece having a lower wall that covers over a lower portion of the sprayer housing;
an upper shroud piece mechanically attached to the lower shroud piece, the upper shroud piece having an upper wall that covers over an upper portion of the sprayer housing and engages with the lower shroud piece with the sprayer housing being enclosed between the lower shroud piece and the upper shroud piece.

2. The trigger sprayer of claim 1, further comprising:
the lower wall and the upper wall engaging along a seam that extends as a line from one side of the pump chamber and around the sprayer housing to an opposite side of the pump chamber.

3. The trigger sprayer of claim 2, further comprising:
the seam between the lower wall and the upper wall having a continuous curved shape with opposite first and second ends, the seam first end being positioned at one side of the pump chamber opening and the seam extending from the seam first end across the one side of the pump chamber around the sprayer housing and across the opposite side of the pump chamber to the seam second end positioned at an opposite side of the pump chamber opening from the seam first end.

4. (canceled)

5. (canceled)

6. The trigger sprayer of claim 1, further comprising:
the upper shroud piece being attached to the lower shroud piece only by mechanical attachments.

7. The trigger sprayer of claim 6, further comprising:
there being no mechanical attachments between the upper shroud piece and the sprayer housing.

8. The trigger sprayer of claim 6, further comprising:
each mechanical attachment that attaches the lower shroud piece to the upper shroud piece consisting of a first part that is integral with the lower shroud piece and a second part that is integral with the upper shroud piece.

9. The trigger sprayer of claim 1, further comprising:
the lower shroud piece lower wall being tubular and surrounding an interior volume of the lower shroud piece, the lower wall having a top edge surrounding a top opening of the lower shroud piece and the lower wall having a bottom edge surrounding a bottom opening of the lower shroud piece.

10. The trigger sprayer of claim 9, further comprising:
the lower shroud piece surrounding the lower portion of the sprayer housing that has the liquid inlet opening, and the upper portion of the sprayer housing extends out from the top opening of the lower shroud piece and is covered by the upper shroud piece.

11. (canceled)

12. A manually operated trigger sprayer comprising:
a sprayer housing having a pump chamber in the sprayer housing with a pump chamber opening on the sprayer housing, a liquid inlet opening on the sprayer housing, a liquid supply passage extending through the sprayer housing and communicating the liquid inlet opening with the pump chamber, a liquid outlet opening on the sprayer housing, and a liquid discharge passage extending through the sprayer housing and communicating the liquid outlet opening with the pump chamber;
a pump piston mounted in the pump chamber for reciprocating movement between charge and discharge positions of the pump piston in the pump chamber;
a trigger mounted on the sprayer housing for movement of the trigger relative to the sprayer housing, the trigger being operatively connected to the pump piston to cause movement of the pump piston in response to movement of the trigger;
a lower shroud piece having an exterior surface covering over a lower portion of the sprayer housing; and,
an upper shroud piece having an exterior surface covering over an upper portion of the sprayer housing, whereby the entire sprayer housing is covered over and does not extend outside of the exterior surfaces of the lower and upper shroud pieces.

13. (canceled)

14. (canceled)

15. (canceled)

16. The trigger sprayer of claim 12, further comprising:
the upper shroud piece being attached to the lower shroud piece only by mechanical attachments.

17. The trigger sprayer of claim 16, further comprising:
each mechanical attachment that attaches the lower shroud piece to the upper shroud piece consisting of a first part that is integral with the lower shroud piece and a second part that is integral with the upper shroud piece.

18. The trigger sprayer of claim 12, further comprising:
the lower shroud piece being tubular and the lower shroud piece exterior surface extending completely around the sprayer housing lower portion, the lower shroud piece exterior surface having a top edge surrounding a top opening of the lower shroud piece and a bottom edge surrounding a bottom opening of the lower shroud piece.

19. The trigger sprayer of claim 18, further comprising:
the lower shroud piece surrounding the lower portion of the sprayer housing that has the liquid inlet opening, and the upper portion of the sprayer housing extending out from the top opening of the lower shroud piece and being covered by the upper shroud piece.

20. (canceled)

21. A manually operated trigger sprayer comprising:
a sprayer housing having a pump chamber in the sprayer housing with a pump chamber opening on the sprayer housing, a liquid inlet opening on the sprayer housing, a liquid supply passage extending through the sprayer housing and communicating the liquid inlet opening with the pump chamber, a liquid outlet opening on the sprayer housing, and a liquid discharge passage extending through the sprayer housing and communicating the liquid outlet opening with the pump chamber;
a pump piston mounted in the pump chamber for reciprocating movement between charge and discharge positions of the pump piston in the pump chamber;
a trigger mounted on the sprayer housing for movement of the trigger relative to the sprayer housing, the trigger being operatively connected to the pump piston to cause movements of the pump piston in response to movement of the trigger;
a lower shroud piece having an exterior surface covering over a lower portion of the sprayer housing;
an upper shroud piece having an exterior surface covering over an upper portion of the sprayer housing; and,
a plurality of two-part, snap-on connectors attaching the lower shroud piece and the upper shroud piece together around the sprayer housing, each two-part, snap-on connector consisting of a first part that is integral with the lower shroud piece and a second part that is integral with the upper shroud piece.

22. The trigger sprayer of claim 21, further comprising:
the two-part, snap-on connectors providing the only connections between the lower shroud piece and the upper shroud piece.

23. The trigger sprayer of claim 21, further comprising:
the lower shroud piece and the upper shroud piece engage along a seam that extends as a continuous line from one side of the pump chamber opening and around the sprayer housing to an opposite, second side of the pump chamber opening.

24. (canceled)

25. (canceled)

26. The trigger sprayer of claim 21, further comprising:
the lower shroud piece being tubular and the lower shroud piece exterior surface extending completely around the sprayer housing lower portion, the lower shroud piece exterior surface having a top edge surrounding a top opening of the lower shroud piece and a bottom edge surrounding a bottom opening of the lower shroud piece.

27. The trigger sprayer of claim 26, further comprising:
a bottle connector on the sprayer housing, the bottle connector being inside the lower shroud piece between the top edge and bottom edge of the lower shroud piece.

28. The trigger sprayer of claim 26, further comprising:
the lower shroud piece surrounding the lower portion of the sprayer housing that has the liquid inlet opening, and the upper portion of the sprayer housing extending out from the top opening of the lower shroud piece and being covered by the upper shroud piece.

29. A manually operated trigger sprayer comprising:
a sprayer housing having a pump chamber in the sprayer housing with a pump chamber opening on the sprayer housing, a liquid inlet opening on the sprayer housing, a liquid supply passage extending through the sprayer housing and communicating the liquid inlet opening with the pump chamber, a liquid outlet opening on the sprayer housing, and a liquid discharge passage extending through the sprayer housing and communicating the liquid outlet opening with the pump chamber;
a pump piston mounted in the pump chamber for reciprocating movement between charge and discharge positions of the pump piston in the pump chamber;
a trigger mounted on the sprayer housing for movement of the trigger relative to the sprayer housing, the trigger being operatively connected to the pump piston to cause movement of the pump piston in response to movement of the trigger;
a tubular lower shroud piece having an exterior surface that surrounds and covers over a lower portion of the sprayer housing that has the liquid inlet opening, the exterior surface having a top edge surrounding a top opening of the lower shroud piece and a bottom edge surrounding a bottom opening of the lower shroud piece, an upper portion of the sprayer housing extending out of the lower shroud piece top opening, the upper portion of the sprayer housing having the liquid discharge passage and the liquid outlet opening; and,
an upper shroud piece attached to the lower shroud piece over the top opening of the lower shroud piece, the upper shroud piece having an exterior surface covering over the upper portion of the sprayer housing.

30. The trigger sprayer of claim 29, further comprising:
the lower shroud piece and the upper shroud piece engage along a seam that extends as a continuous line from one side of the pump chamber opening and around the sprayer housing to an opposite, second side of the pump chamber opening.

31. The trigger sprayer of claim 30, further comprising:
the upper shroud piece exterior surface extending as a continuous surface from the seam on one side of the pump chamber and around the liquid discharge passage and the liquid outlet opening of the sprayer housing to the seam on an opposite, second side of the pump chamber.

32. The trigger sprayer of claim 29, further comprising:
the upper shroud piece being attached to the lower shroud piece only by mechanical attachments.

33. The trigger sprayer of claim 32, further comprising:
each mechanical attachment that attaches the lower shroud piece to the upper shroud piece consisting of a first part that is integral with the lower shroud piece and a second part that is integral with the upper shroud piece.

34. The trigger sprayer of claim 29, further comprising:
a bottle connector on the sprayer housing, the bottle connector extending around the liquid inlet opening, and the bottle connector being positioned inside the lower shroud piece between the top opening and the bottom opening of the lower shroud piece.
